(19) United States
(12) Patent Application Publication
(10) Pub. No.: US 2010/0150340 A1
(43) Pub. Date: Jun. 17, 2010

(54) DEVICE AND METHOD FOR ELLIPTIC CURVE CRYPTOSYSTEM

(75) Inventors: Yong-Je CHOI, Daejeon (KR); Doo Ho CHOI, Cheonan-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/566,867

(22) Filed: Sep. 25, 2009

(30) Foreign Application Priority Data
Dec. 2, 2008 (KR) 10-2008-0121433
Apr. 15, 2009 (KR) 10-2009-0032927

(51) Int. Cl. H04L 9/28

(52) U.S. Cl. 380/28

(57) ABSTRACT

An exemplary embodiment of the present invention provides a method and an apparatus for minimizing a difference in data path between elliptic curve point addition and elliptic curve point doubling. An elliptic curve encryption method includes a first operation step of performing point addition for two points when two points on an elliptic curve are different from each other, and a second operation step of performing point doubling for any one point when two points on the elliptic curve are the same, wherein inverse multiplication processes and multiplication processes of the first operation step and the second operation step have the same path delay.

### CROSS-REFERENCE TO RELATED APPLICATION

This application claims priority to and the benefit of Korean Patent Application Nos. 10-2008-0121433 and 10-2009-0032927 filed in the Korean Intellectual Property Office on Dec. 2, 2008 and Apr. 15, 2009, the entire contents of which are incorporated herein by reference.

### BACKGROUND OF THE INVENTION

(a) Field of the Invention

An exemplary embodiment of the present invention relates to a method and an apparatus for minimizing a difference in data path between elliptic curve point addition and elliptic curve point doubling.

(b) Description of the Related Art

Recently, information security has been recognized as a very important problem because of the rapid growth of the Internet and wireless communication. Implementation of a cryptosystem is required for information security. In recent years, the academic world and the industrial world have taken a large interest in an elliptic curve cryptosystem (ECC) of the cryptosystems.

The ECC is a cryptosystem that implements encryption/decoding on the basis of a special addition method defined on a mathematical object called an elliptic curve. The ECC has a key advantage of having the same safety while using a key that is smaller than other cryptosystems such as RSA or ELGamal.

Since the ECC is vulnerable to side channel attacks such as a power analysis attack, a fault injection attack, etc. in spite of the advantage, the ECC needs to be enhanced.

The side channel attacks generally represent techniques of acquiring information relating to an internal encryption key by measuring physical characteristics such as an execution time on communication, power consumption, electromagnetic wave irradiation, etc. from a side channel. The side channel attack on an elliptic curve encryption uses a difference of operation power consumption caused by discordance of a data path delay between elliptic curve point addition and elliptic curve point doubling.

The elliptic curve addition and the elliptic curve point doubling can be defined in Equation 1.

(Equation 1)

| Input: | P₀ = (x₀, y₀), P₁ = (x₁, y₁) |
|---|---|
| Output: | P₂ = P₀ + P₁ = (x₂, y₂) |
| 1. | If P₀ = P₁ (point doubling) |
| | x₂ = λ² + λ + a, y₂ = x₀² + (λ + 1)x₂ |
| | where (λ = x₀ + y₀/x₀) |
| 2. | Else if P₀ ≠ P₁ (point addition) |
| | x₂ = λ₂ + λ + x₀ + x₁ + a, y₂ = λ (x₀ + x₂) + x₂ + y₀ |
| | where (λ = (y₁ + y₀)/(x₁ + x₀)) |
| 3. | Return (x₂, y₂) |

In general, the largest operation delay is generated in division of an elliptic curve encryption operation. However, as shown in Equation 1, operation sequences of λ including inverse multiplication during an operation of y₂ of the elliptic curve addition and y₂ of the elliptic curve point doubling are different from each other, such that there is a large difference in data path delay.

Although a new algorithm may be proposed in order to solve the problem, much time and cost are required, and as a result, many new logics must be developed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for minimizing a difference in data path between elliptic curve addition and elliptic curve point doubling that constitute an elliptic curve encryption operation, and an operation device therefor.

An exemplary embodiment of the present invention provides an elliptic curve encryption method that includes a first operation step of performing point addition for two points when two points on an elliptic curve are different from each other, and a second operation step of performing point doubling for any one point when two points on the elliptic curve are the same as each other, wherein inverse multiplication processes and multiplication processes of the first operation step and the second operation step have the same path delay.

Herein, the second operation step may include: receiving coordinates of a first point and a second point on the elliptic curve; a first inverse multiplication step of inverse-multiplying an input X coordinate of the first point; a first multiplication step of multiplying an input Y coordinate of the first point and an output value of the first inverse multiplication step; a first addition step of adding the input X coordinate of the first point and the result value of the first multiplication step; a second addition step of adding the input X coordinate of the first point and an input X coordinate of the second point; a second multiplication step of multiplying a result value of the first addition step and a result value of the second addition step; and a third addition step of adding the result value of the second multiplication step and an output X coordinate of the second point and an input Y coordinate of the first point.

Further, the first operation step may include: a fourth addition step of adding the input X coordinate of the second point and the input X coordinate of the first point; a fifth addition step of adding an output Y coordinate of the second point and an output Y coordinate of the first point; a second inverse multiplication step of inverse-multiplying an output value of the fourth addition step; a third multiplication step of multiplying an output value of the second inverse multiplication step and an output value of the fifth addition step; a sixth addition step of adding the input X coordinate of the first point and the input X coordinate of the second point; a fourth multiplication step of multiplying a result value of the third multiplication step and a result value of the sixth addition step; and a seventh addition step of adding a result value of the fourth multiplication step and the output X coordinate of the second point and the input Y coordinate of the first point.

Another embodiment of the present invention provides an elliptic curve encryption apparatus that includes a first operation device performing point addition for two points when two points on an elliptic curve are different from each other, and a second operation device performing point doubling for any one point when two points on the elliptic curve are the same as each other, wherein inverse multiplication and multiplication of the first operation device and the second device have the same path delay.

Herein, the second operation device may include: a plurality of registers for storing input coordinates and output coordinates of first and second points on the elliptic curve; a first inverse multiplier for inverse-multiplying an input X coordinate of the first point; a first multiplier for multiplying an input Y coordinate of the first point and an output value of the first inverse multiplier; a first adder for adding the input X coordinate of the first point and a result value of the first multiplier; a second adder for adding the input X coordinate of the first point and an input X coordinate of the second point; a second multiplier for multiplying a result value of the first adder and a result value of the second adder; and a third adder for adding the result value of the second multiplier and an output X coordinate of the second point and an input Y coordinate of the first point.

Further, the first operation device may include: a fourth adder for adding the input X coordinate of the second point and the input X coordinate of the first point; a fifth adder for adding an output Y coordinate of the second point and an output Y coordinate of the first point; a second inverse multiplier for inverse-multiplying an output value of the fourth adder; a third multiplier for multiplying an output value of the second inverse multiplier and an output value of the fifth adder; a sixth adder for adding the input X coordinate of the first point and the input X coordinate of the second point; a fourth multiplier for multiplying a result value of the third multiplier and a result value of the sixth adder; and a seventh adder for adding a result value of the fourth multiplier and the output X coordinate of the second point and the input Y coordinate of the first point.

Meanwhile, the elliptic curve encryption apparatus according to the embodiment of the present invention may further include a switch and a plurality of multiplexers for controlling to perform the operations of the first multiplier, the second multiplier, the third multiplier, and the fourth multiplier with one multiplier, and to perform the operations of the first inverse multiplier and the second inverse multiplier with one inverse multiplier.

According to an exemplary embodiment of the present invention, since it is possible to minimize a difference in data path between elliptic curve addition and elliptic curve point doubling for elliptic curve encryption by minimum logic change, it is possible to defend side channel attacks at a minimum cost.

### BRIEF DESCRIPTION OF THE DRAWINGS

FIG. 1 is a block diagram illustrating a configuration of a first operation device that is a part of an elliptic curve operation device in an operation sequence according to an exemplary embodiment of the present invention.

FIG. 2 is a block diagram illustrating a configuration of a second operation device that is a part of an elliptic curve operation device in an operation sequence according to an exemplary embodiment of the present invention.

FIG. 3 is a block diagram illustrating a configuration of an elliptic curve operation device in an operation sequence according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

In addition, throughout this specification, unless explicitly described to the contrary, the word “comprise” and variations such as “comprises” or “comprising”, will be understood to imply the inclusion of stated elements but not the exclusion of any other elements.

The performance of an elliptic curve encryption algorithm is generally determined by scalar multiplication. The scalar multiplication is defined by multiplying a predetermined random integral k by one point P on an elliptic curve and defined by adding the point P on the elliptic curve k times. At this time, an addition result of the elliptic curve can be defined in Equation 2 to be the point on the elliptic curve again.

(Equation 2)

| Input: | P₀ = (x₀, y₀), P₁ = (x₁, y₁) |
|---|---|
| Output: | P₂ = P₀ + P₁ = (x₂, y₂) |
| 1. | If P₀ = P₁ (point doubling) |
| | x₂ = λ² + λ + a, y₂ = λ (x₀ + x₂) + x₂ + y₀ |
| | where (λ = x₀ + y₀/x₀) |
| 2. | Else if P₀ ≠ P₁ (point addition) |
| | x₂ = λ₂ + λ + x₀ + x₁ + a, y₂ = λ (x₀ + x₂) + x₂ + y₀ |
| | where (λ = (y₁ + y₀)/(x₁ + x₀)) |
| 3. | Return (x₂, y₂) |

A process in which the elliptic curve operation device according to the embodiment of the present invention performs the point addition of Table 2 will be described in detail below.

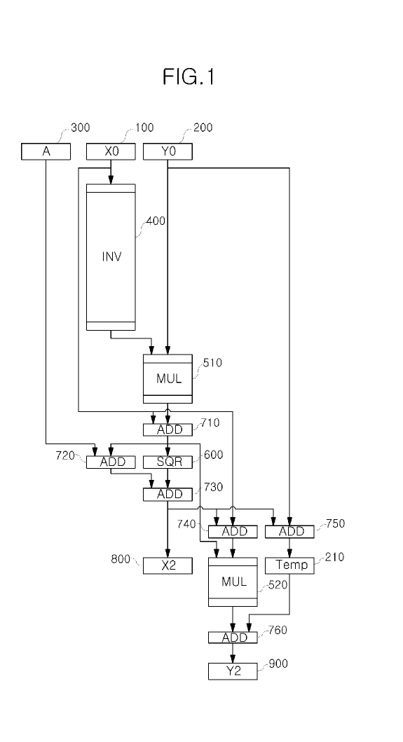

FIG. 1 is a block diagram illustrating a first operation device that is a part of an elliptic curve operation device according to an exemplary embodiment of the present invention. The first operation device performs point doubling of Table 2.

In FIG. 1, the first operation device according to the embodiment of the present invention includes an X0 register 100 storing an input value, an output value, and an intermediate operation value of elliptic curve point doubling in an affine coordinate, a Y0 register 200, a temporary register 210, an X2 register 800, a Y2 register 900, an A register 300 storing an elliptic curve parameter, an inverse multiplier 400, multipliers 510 and 520, a square multiplier 600, and adders 710, 720, 730, 740, 750, and 760.

The inverse multiplier 400 performs inverse multiplication of 1/x₀ by receiving x₀ from the X0 register 100, and the multiplier 510 calculates y₀/x₀ by receiving y₀ and 1/x₀ from the Y0 register 200 and the inverse multiplier 400, respectively.

The adder 710 calculates λ by adding X₀ to an output value of the multiplier 510, and transfers the calculated λ to the square multiplier 600, the adder 720, and the multiplier 520.

The adder 720 adds the output λ of the adder 710 to an output a of the A register 300, and the square multiplier 600 squares the result value λ of the adder 710.

The adder 730 adds the output λ² of the square multiplier 600 to the output λ+a of the adder 720, and outputs the added output to the adder 740, the adder 750, and the X2 register 800.

The adder 740 adds the output values of the X0 register 100 and the adder 730, and the adder 750 adds the output values of the Y0 register 200 and the adder 730. Then the adder 750 stores the outputs in the temporary register 210.

When the multiplier 520 multiplies the result values of the adder 710 and the adder 740 by each other and outputs the multiplied value to the adder 760, the adder 760 adds the output values of the X2 register 800, the adder 520, and the temporary register 210, and stores the added value in the Y2 register 900.

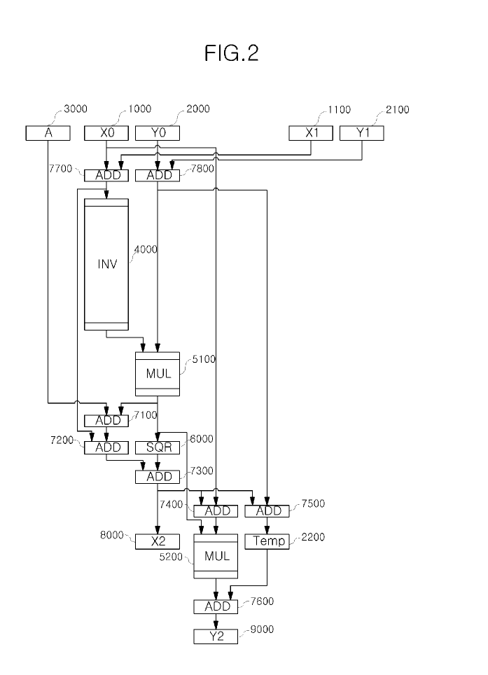

FIG. 2 is a block diagram illustrating a second operation device that is a part of an elliptic curve operation device according to an exemplary embodiment of the present invention.

The second operation device performs point addition of Table 2.

In FIG. 2, the second operation device according to the embodiment of the present invention includes an X0 register 1000 storing an input value, an output value, and an intermediate operation value of elliptic curve point doubling in an affine coordinate, a Y0 register 2000, an X1 register 1100, a Y1 register 2100, a temporary register 2200, an X2 register 8000, a Y2 register 9000, an A register 3000 storing an elliptic curve parameter a, an inverse multiplier 4000, multipliers 5100 and 5200, a square multiplier 6000, and adders 7100, 7200, 7300, 7400, 7500, 7600, 7700, and 7800.

The adder 7700 adds stored values of the X0 register 1000 and the X1 register 1100 to determine x₀+x₁, and the adder 7800 adds stored values of the Y0 register 2000 and the Y1 register 2100 to determine y₀+y₁.

The inverse multiplier 4000 performs inverse multiplication of 1/(x₀+x₁) from the output of the adder 7700, and the multiplier 5100 calculates A by multiplying the output value (y₀+y₁) of the adder 7800 by the output value 1/(x₀+x₁) of the inverse multiplier 4000.

When the adder 7100 calculates λ+a by adding the output value of the multiplier 5100 and the output value of the A register 3000, the adder 7200 adds the output of the adder 7100 and the output of the adder 7700 and the square multiplier 6000 squares the result value λ of the multiplier 5100.

The adder 7300 adds the output λ+a of the adder 7200 and the output λ² of the multiplier 5200, and outputs the added value to the adder 7400, the adder 7500, and the X2 register 8000.

The adder 7400 adds the output values of the X0 register 1000 and the adder 7300, and the adder 7500 adds the output values of the adder 7800 and the adder 7300. Then the adder 7500 stores the added value in the temporary register 2200.

When the multiplier 5200 multiplies the result values of the adder 5100 and the adder 7400 by each other and outputs the multiplied value to the adder 7600, and the adder 7600 adds the output values of the multiplier 5200 and the temporary register 2200 and stores the added value in the Y2 register 9000.

When FIG. 1 and FIG. 2 are compared with each other, the data path delay between the elliptic curve point doubling and the elliptic curve point addition shows a partial difference before the inverse multiplication process and after the multiplication process, and hardly any differences in the inverse multiplication process and the multiplication process.

Since a division time is longer than an addition or multiplication time in the elliptic curve encryption operation, the side channel attacks using the path delay difference are interrupted by making the data delay paths in the inverse multiplication for the point doubling and the point addition the same.

Although the elliptic curve encryption operation device that is separately provided with the first operation device for the point doubling and the second operation device for the point addition has been described, the first and second operation devices may share overlapped components having the same function in the first and second operation devices.

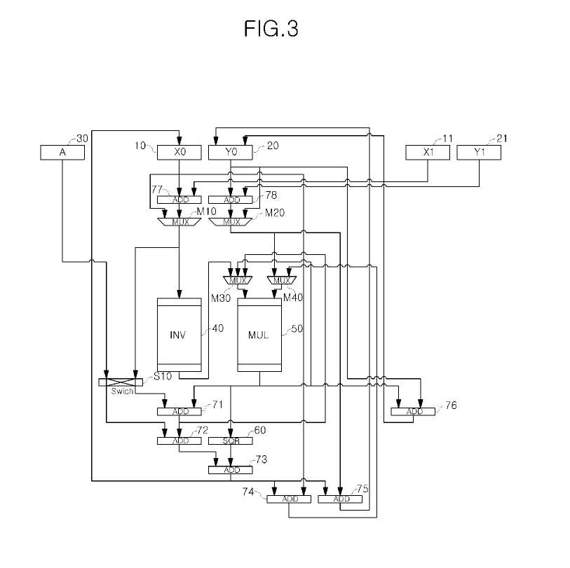

FIG. 3 is a block diagram illustrating a configuration of an elliptic curve operation device in an operation sequence according to an exemplary embodiment of the present invention.

In FIG. 3, the elliptic curve operation device according to the embodiment of the present invention includes an X0 register 10 storing an input value, an output value, and an intermediate operation value of elliptic curve point doubling and elliptic curve point addition in an affine coordinate, a Y0 register 20, an X1 register 11, a Y1 register 21, an A register 30 storing an elliptic curve parameter a, an inverse multiplier 40, a multiplier 50, a square multiplier 60, and adders 71, 72, 73, 74, 75, 76, 77, and 78.

In addition, the elliptic curve operation device further includes a switch S10 for changing a data path depending on an operation mode, multiplexers M10, M20, M30, and M40 for selecting the input value depending on the operation mode, and a controller C10 for controlling outputs of the switch S10 and the multiplexers M10, M20, M30, and M40. The operation mode includes a first operation mode for the point doubling and a second operation mode for the point addition.

First, the first operation process for the point doubling will be described below.

The controller C10 sets a current mode as the first operation mode when two points on the elliptic curve are inputted and turned out the same.

When the controller C10 selects the output of the X0 register 10 by controlling the multiplexer M10, the inverse multiplier 40 performs inverse multiplication of 1/x₀ by receiving x₀ from the X0 register 10.

Subsequently, when the controller C10 selects the output of the Y0 register 20 by controlling the multiplexer M40 and selects the output of the inverse multiplier 40 by controlling the multiplexer M30, the multiplier 50 calculates y₀/x₀ by receiving y0 and 1/x₀ from the Y0 register 20 and the inverse multiplier 40, respectively.

Subsequently, when the controller C10 selects the output of the X0 register 10 by controlling the switch S10, the adder 71 calculates A by adding the output value of the multiplier 50 and x₀, and transfers the added value to the square multiplier 60, the adder 72, and the multiplier 50.

Subsequently, when the controller C10 selects the output of the A register 30 by controlling the switch S10, the adder 72 adds the output a of the A register 30 and the output λ of the adder 71, and the square multiplier 60 squares the result value λ of the adder 71.

The adder 73 adds the output λ+a of the adder 72 and the output λ² of the square multiplier 60 and outputs the added value to the adder 74, the adder 75, and the X0 register 10.

The adder 74 adds the output values of the X0 register 10 and the adder 73, and the adder 75 adds the output values of the Y0 register 20 and the adder 73. Then the adder 75 stores the added value in the Y0 register 20. Prior to the adding in the adder 75, the controller C10 selects the output of the Y0 register 20 by controlling the multiplexer M20.

Subsequently, when the controller C10 selects the output of the result values of the adder 71 and the adder 74 by controlling the multiplexer M30 and the multiplexer M40, the multiplier 50 multiplies the result values of the adder 71 and the adder 74 and outputs the multiplied value to the adder 76. The adder 76 adds the output values of the Y0 register 20 and the adder 50 and stores the added value in the Y0 register 20 again.

Consequently, the value of x₂=λ²+λ+a and the value of y₂=λ(x₀+x₂)+x₂+y₀ are stored in the X0 register 10 and the Y0 register 20, respectively.

Next, the second operation process for the point addition will be described below.

The controller C10 sets a current mode as the second operation mode when two points on the elliptic curve are inputted and turned out to be different from each other.

The adder 77 adds stored values of the X0 register 10 and the X1 register 11 to determine x₀+x₁, and the adder 78 adds stored values of the Y0 register 20 and the Y1 register 21 to determine y₀+y₁.

When the controller C10 selects the output of the adder 77 by controlling the multiplexer M10, the inverse multiplier 40 performs inverse multiplication of 1/(x₀+x₁) from the output of the adder 77. Further, when the controller C10 selects the output of the adder 78 by controlling the multiplexer M12, the multiplier 50 calculates A by multiplying the output value (y₀+y₁) of the adder 78 and the output value of 1/(x₀+x₁) of the inverse multiplier 40.

Subsequently, when the controller C10 selects the output of the A register 30 by controlling the switch S10, the adder 71 calculates λ+a by adding the output value of the multiplier 50 and the output value of the A register 30.

Then, when the controller C10 selects the output of the adder 77 by controlling the multiplexer M10 and the switch S10, the adder 72 adds the output of the adder 71 and the output of the adder 77, and the square multiplexer 60 squares the result value λ of the multiplier 50.

The adder 73 adds the output λ+a of the adder 72 and the output λ² of the multiplier 50, and outputs the added value to the adder 74, the adder 75, and the X0 register 10. Subsequently, the adder 74 adds the output values of the X0 register 10 and the adder 73, and the adder 75 adds the output values of the adder 78 and the adder 73. Then the adder 75 stores the added value in the Y0 register 20. Prior to the adding in the adder 75, the controller C10 selects the output of the adder 78 by controlling the multiplexer M20.

Subsequently, when the controller C10 selects the output of the multiplier 50 and the output of the adder 74 by controlling the multiplexer M30 and the multiplexer M40, the multiplier 50 multiplies the result values of the multiplier 50 and the adder 74 by each other and outputs the multiplied value to the adder 76, and the adder 76 adds the output values of the multiplier 50 and the Y0 register 20 and stores the added value in the Y0 register 20 again. Accordingly, the result values stored in the X0 register 10 and the Y0 register 20 become x₂ and y₂, respectively. In the embodiment of FIG. 3, the X0 register 10 and the Y0 register 20 are substituted without an additional X2 register and Y2 register, but the X2 register and the Y2 register may be additionally provided.

In this case, the output of the adder 73 and the output of the adder 76 are connected to the X2 register (not shown) and the Y2 register (not shown), respectively, in the first operation mode. Further, the output of the adder 73 and the output of the adder 76 are connected to the X2 register (not shown) and the Y2 register (not shown), respectively, in the second operation mode.

Meanwhile, according to the embodiment of the present invention, the first operation device, the second operation device, and the elliptic curve encryption operation device including the same can be implemented by a field programmable gate array (FPGA) or an application-specific integrated circuit (ASIC).

The embodiments of the present invention described above are implemented not only by the apparatus, and may be implemented by a program embodying a function corresponding to the configuration of the embodiment of the present invention or a recording medium in which the program is recorded. Further, the implementation can be easily made with reference to the above-mentioned embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An elliptic curve encryption method, comprising:
a first operation step of performing point addition for two points when two points on an elliptic curve are different from each other; and
a second operation step of performing point doubling for any one point when two points on the elliptic curve are the same,
wherein inverse multiplication processes and multiplication processes of the first operation step and the second operation step have the same path delay.

2. The method of claim 1, wherein the second operation step comprising:
receiving coordinates of a first point and a second point on the elliptic curve;
a first inverse multiplication step of inverse-multiplying an input X coordinate of the first point;
a first multiplication step of multiplying an input Y coordinate of the first point and an output value of the first inverse multiplication step;
a first addition step of adding the input X coordinate of the first point and the result value of the first multiplication step;
a second addition step of adding the input X coordinate of the first point and an input X coordinate of the second point;
a second multiplication step of multiplying a result value of the first addition step and a result value of the second addition step; and
a third addition step of adding the result value of the second multiplication step and an output X coordinate of the second point and an input Y coordinate of the first point.

3. The method of claim 2, wherein: the first operation step comprising:
a fourth addition step of adding the input X coordinate of the second point and the input X coordinate of the first point;
a fifth addition step of adding an output Y coordinate of the second point and an output Y coordinate of the first point;
a second inverse multiplication step of inverse-multiplying an output value of the fourth addition step;
a third multiplication step of multiplying an output value of the second inverse multiplication step and an output value of the fifth addition step;
a sixth addition step of adding the input X coordinate of the first point and the input X coordinate of the second point;
a fourth multiplication step of multiplying a result value of the third multiplication step and a result value of the sixth addition step; and
a seventh addition step of adding a result value of the fourth multiplication step, the output X coordinate of the second point, and the input Y coordinate of the first point.

4. An elliptic curve encryption apparatus, comprising:
a first operation device performing point addition for two points when two points on an elliptic curve are different from each other; and
a second operation device performing point doubling for any one point when two points on the elliptic curve are the same,
wherein inverse multiplication and multiplication of the first operation device and the second device have the same path delay.

5. The apparatus of claim 4, wherein the second operation device comprising:
a plurality of registers for storing input coordinates and output coordinates of first and second points on the elliptic curve;
a first inverse multiplier for inverse-multiplying an input X coordinate of the first point;
a first multiplier for multiplying an input Y coordinate of the first point and an output value of the first inverse multiplier;
a first adder for adding the input X coordinate of the first point and a result value of the first multiplier;
a second adder for adding the input X coordinate of the first point and an input X coordinate of the second point;
a second multiplier for multiplying a result value of the first adder and a result value of the second adder; and
a third adder for adding the result value of the second multiplier and an output X coordinate of the second point and an input Y coordinate of the first point.

6. The apparatus of claim 5, wherein the first operation device comprising:
a fourth adder for adding the input X coordinate of the second point and the input X coordinate of the first point;
a fifth adder for adding an output Y coordinate of the second point and an output Y coordinate of the first point;
a second inverse multiplier for inverse-multiplying an output value of the fourth adder;
a third multiplier for multiplying an output value of the second inverse multiplier and an output value of the fifth adder;
a sixth adder for adding the input X coordinate of the first point and the input X coordinate of the second point;
a fourth multiplier of multiplying a result value of the third multiplier and a result value of the sixth adder; and
a seventh adder of adding a result value of the fourth multiplier and the output X coordinate of the second point and the input Y coordinate of the first point.

7. The apparatus of claim 6, further comprising
a switch and a plurality of multiplexers for controlling to perform the operations of the first multiplier, the second multiplier, the third multiplier, and the fourth multiplier with one multiplier, and to perform the operations of the first inverse multiplier and the second inverse multiplier with one inverse multiplier.
